(19) United States
(12) Patent Application Publication
(10) Pub. No.: US 2025/0070361 A1
(43) Pub. Date: Feb. 27, 2025

(54) MULTILAYER BATTERY PACK INSULATOR WITH MECHANICALLY JOINED LAYERS

(71) Applicant: FEDERAL-MOGUL POWERTRAIN LLC, Northville, MI (US)

(72) Inventors: Zobar Hassan, Northville, MI (US); Ritesh Mehbubani, Rogersford, PA (US); Jordan Zachary Boatwright, York, PA (US)

(21) Appl. No.: 18/812,986

(22) Filed: Aug. 22, 2024

Related U.S. Application Data
(60) Provisional application No. 63/534,471, filed on Aug. 24, 2023.
(60) Provisional application No. 63/534,473, filed on Aug. 24, 2023.

(51) Int. Cl. H01M 50/249; B32B 5/02; B32B 5/26; B32B 37/12; B32B 37/24; B32B 38/00; D02G 3/02; D02G 3/18; D02G 3/44; D03D 15/242; D03D 15/267; H01M 50/276; H01M 50/383

(52) U.S. Cl. CPC H01M 50/249; B32B 5/024; B32B 5/263; B32B 37/12; B32B 37/24; B32B 38/0004; D02G 3/02; D02G 3/18; D02G 3/446; D03D 15/242; D03D 15/267; H01M 50/276; H01M 50/383; B32B 2037/243; B32B 2038/008; B32B 2250/20; B32B 2250/40; B32B 2255/02; B32B 2255/20; B32B 2255/26; B32B 2262/101; B32B 2262/105; B32B 2305/188; B32B 2307/304; B32B 2307/3065; B32B 2315/02; B32B 2315/085; B32B 2457/10; B32B 2605/00; D10B 2101/00; D10B 2101/02; H01M 2220/20

(57) ABSTRACT

A flexible multilayer battery pack insulator for an electric vehicle has a multilayer wall including a plurality of layers of interlaced mineral material including an inner layer having a first exposed, outwardly facing surface and an outer layer having a second exposed, outwardly facing surface. A first flame-resistant coating is bonded to at least one of the plurality of layers. A pressure-sensitive adhesive is bonded to the first exposed, outwardly facing surface of the inner layer. At least one filament fixes the plurality of layers to one another.

### CROSS-REFERENCE TO RELATED APPLICATIONS

This application claims the benefit of U.S. Provisional Application Ser. No. 63/534,471, filed Aug. 24, 2023, and the benefit of U.S. Provisional Application Ser. No. 63/534,473, filed Aug. 24, 2023, which are both incorporated herein by reference in their entirety.

### BACKGROUND OF THE INVENTION

### 1. Technical Field

This invention relates generally to thermal insulators, and more particularly to multilayer thermal insulators for inhibiting flame propagation from a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. The fiberglass insulator can result in a thermal runaway condition originating in any one of the cells of the battery pack, such that flame propagates outwardly from the battery pack in less than 5 minutes at a temperature of 1000° C.

It is desired to provide a thermal insulation that inhibits the propagation of flame outwardly from a battery case of a battery pack for 10 minutes or more at a temperature of 800° C.-1500° C.

### SUMMARY OF THE INVENTION

It is an object of the present disclosure to provide a multilayer material for use with an electric vehicle battery pack that addresses at least the desire to inhibit the propagation of flame from the battery pack for 10 minutes or more at a temperature of 800° C.-1500° C.

It is a further object of the present disclosure to provide a multilayer material for use with an electric vehicle battery pack that minimizes the amount of flame fuel present within the multilayer material.

It is a further object of the present disclosure to provide a multilayer material for use with an electric vehicle battery pack that is flexible, lightweight, has a thin, low profile to minimize the amount of space occupied by the thermal insulator, and is economical in manufacture and in use.

One aspect of the invention provides a flexible multilayer battery pack insulator for an electric vehicle. The insulator has a multilayer wall including an outer layer, an intermediate layer, and an inner layer. The outer layer is formed of interlaced mineral yarns, and has an outer surface and an inner surface. A first flame-resistant coating is bonded to the outer surface of the outer layer. The intermediate layer is formed of interlaced mineral yarns. A second flame-resistant coating is bonded to the intermediate layer. The inner layer is formed of interlaced mineral yarns. The intermediate layer is disposed between the outer layer and the inner layer. A pressure-sensitive adhesive is bonded to the inner layer, with the pressure-sensitive adhesive facing away from the intermediate layer. At least one filament fixes the outer layer, the intermediate layer, and the inner layer to one another.

In accordance with another aspect of the invention, the interlaced mineral yarns of said outer layer are silica.

In accordance with another aspect of the invention, the interlaced mineral yarns of said outer layer are woven.

In accordance with another aspect of the invention, the interlaced mineral yarns of said intermediate layer are ceramic.

In accordance with another aspect of the invention, the interlaced mineral yarns of said intermediate layer are woven.

In accordance with another aspect of the invention, the interlaced mineral yarns of said inner layer are fiberglass.

In accordance with another aspect of the invention, the interlaced mineral yarns of said inner layer are woven.

In accordance with another aspect of the invention, the outer layer, said intermediate layer, and said inner layer are not bonded to one another with an adhesive material.

In accordance with another aspect of the invention, the pressure-sensitive adhesive layer is the only adhesive layer of said multilayer wall.

In accordance with another aspect of the invention, the interlaced mineral yarns of said intermediate layer are encapsulated by said second flame-resistant coating.

In accordance with another aspect of the invention, the second flame-resistant coating is one of silica, vermiculite, and graphite.

In accordance with another aspect of the invention, the first flame resistant coating is a silicone-based coating.

In accordance with another aspect of the invention, the first flame resistant coating is silicone.

In accordance with another aspect of the invention, the flexible multilayer wall prevents flame propagation when exposed to temperatures between about 800-1500° C. for a continuous duration of 10 minutes.

In accordance with another aspect of the invention, the multilayer wall has a maximum thickness of about 2 mm.

In accordance with another aspect of the invention, a method of constructing a flexible multilayer battery pack insulator includes: interlacing mineral material to form an outer layer having an outer surface and an inner surface; bonding a first flame-resistant coating to the outer surface of the outer layer; interlacing mineral material to form an intermediate layer; bonding a second flame-resistant coating to the intermediate layer; interlacing mineral material to form an inner layer; arranging the intermediate layer between the outer layer and the inner layer; stitching at least one filament and fixing the outer layer, the intermediate layer, and the inner layer to one another to form a multilayer wall; bonding a pressure-sensitive adhesive to the inner layer; and cutting the multilayer wall to size.

In accordance with another aspect of the invention, the method further includes leaving the outer layer, the intermediate layer, and the inner layer in detached relation from one another other than where stitched together by the at least one filament.

In accordance with another aspect of the invention, the method further includes using a mineral yarn coated with a fire-resistant coating for the at least one filament.

In accordance with another aspect of the invention, the method further includes using polytetrafluoroethylene for the fire-resistant coating.

In accordance with another aspect of the invention, the method further includes using fiberglass or silica for the mineral yarn of the at least one filament.

In accordance with another aspect of the invention, the method further includes using mineral yarn to weave or knit at least one of the inner, intermediate, and/or outer layer.

In accordance with another aspect of the invention, a flexible multilayer battery pack insulator for an electric vehicle has a multilayer wall including a plurality of layers of interlaced mineral material. The plurality of layers include an inner layer having a first exposed, outwardly facing surface and an outer layer having a second exposed, outwardly facing surface. A first flame-resistant coating is bonded to at least one of the plurality of layers. A pressure-sensitive adhesive is bonded to the first exposed, outwardly facing surface of the inner layer. At least one filament fixes the plurality of layers to one another.

In accordance with another aspect of the invention, a method of constructing a flexible multilayer battery pack insulator, includes: interlacing mineral material to form an outer layer having an outer surface and an inner surface; bonding a first flame-resistant coating to the outer surface of the outer layer; interlacing mineral material to form an inner layer; arranging the outer layer and the inner layer in overlying relation with one another; stitching at least one filament and fixing the outer layer and the inner layer to one another with the stitched filament to form a multilayer wall; bonding a pressure-sensitive adhesive to the inner layer; and cutting the multilayer wall to size.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a multilayer thermal insulator constructed in accordance with an aspect of the invention;

FIG. 2 is a schematic cross-sectional side view taken generally along the line 2-2 of FIG. 3 illustrating a multilayer thermal insulator in accordance with a non-limiting embodiment of the disclosure;

FIG. 3 is an assembled fragmentary perspective view of the multilayer thermal insulator of FIG. 2;

FIG. 4 is an exploded view of the multilayer thermal insulator of FIG. 3;

FIG. 5 is a view similar to FIG. 2 of a multilayer thermal insulator constructed in accordance with another aspect of the invention;

FIG. 6 is a view similar to FIG. 3 of the multilayer thermal insulator of FIG. 5; and

FIG. 7 is a view similar to FIG. 4 of the multilayer thermal insulator of FIG. 6.

### DETAILED DESCRIPTION OF PREFERRED EMBODIMENTS

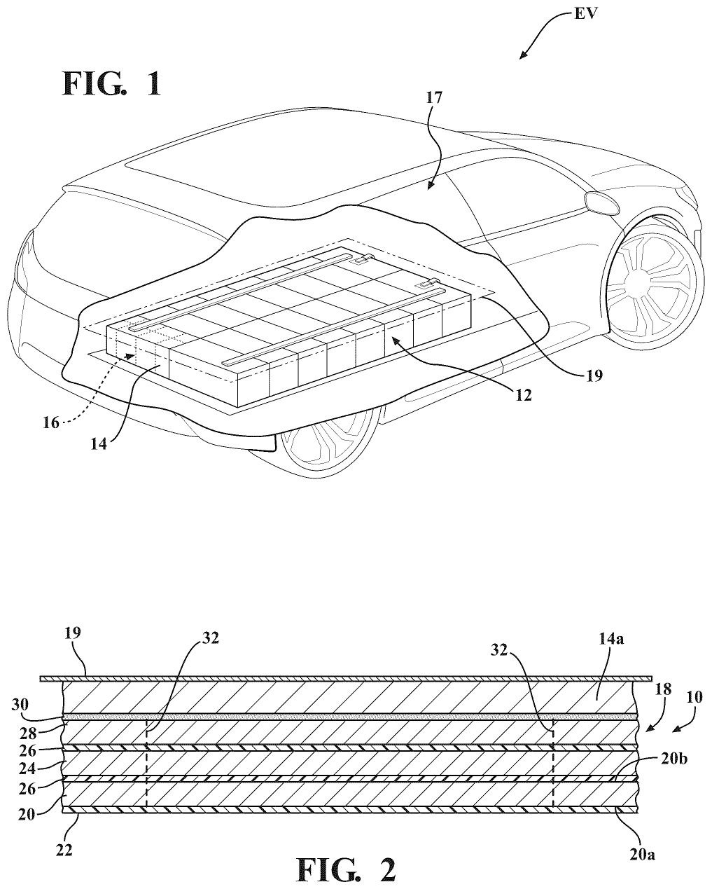

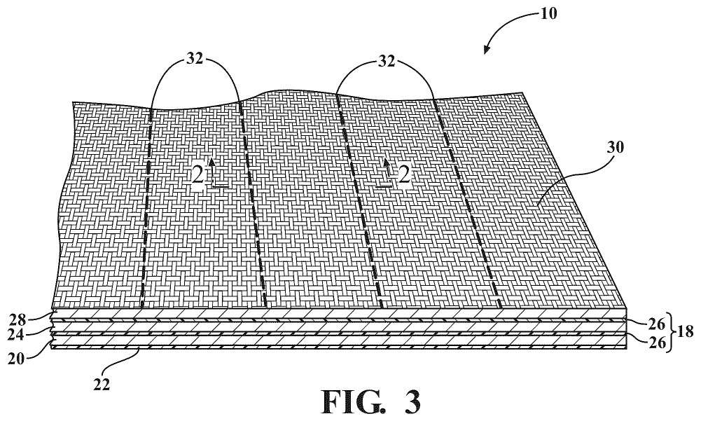

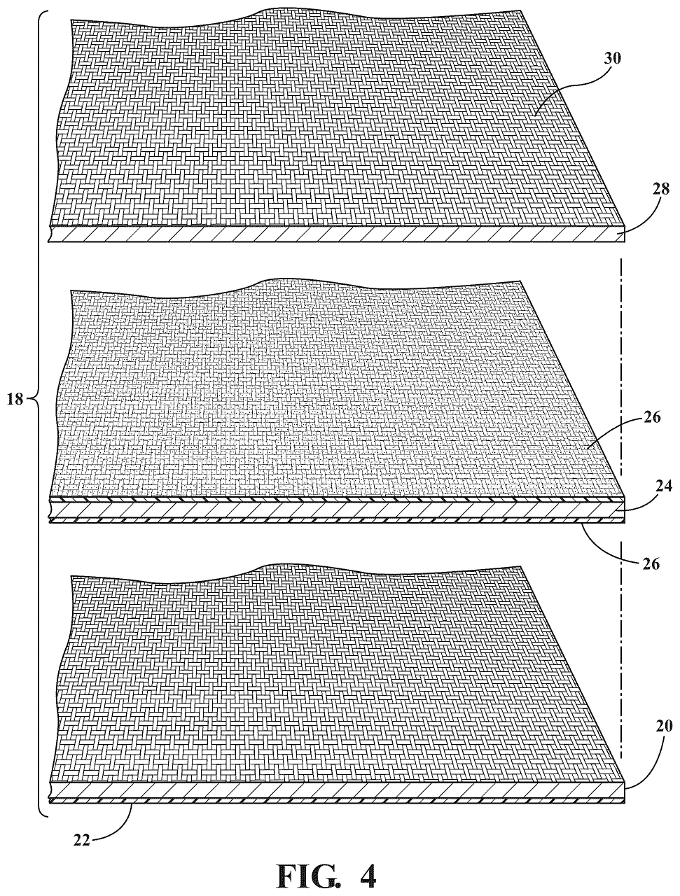

Referring in more detail to the drawings, FIG. 1 illustrates a motor vehicle, shown as an electrically powered motor vehicle, also referred to as electric vehicle EV, having a battery pack 12, such as a lithium-ion battery pack, configured with a flexible multilayer battery pack insulator, referred to hereafter as insulator 10, constructed and shown in accordance with an aspect of the invention, by way of example and without limitation. The electric vehicle battery pack 12 includes a housing member, also referred to as housing or casing 14 bounding a plurality of cells 16 (shown in FIG. 1 in hidden in one cell pack to avoid cluttering the figure), and including bus-bars interconnecting cells, high voltage electrical connectors, cell interfaces, low voltage signal wires, high voltage cables and a cooling system having cooling tubes through which coolant can flow, as is generally known in electric vehicle battery packs. During normal use, and including in non-normal situations, such as in a vehicle crash condition or some other condition causing an impact force to battery pack 12, in contrast to a battery pack 12 not having a multilayer thermal insulator, also referred to as insulator 10, as disclosed herein, a thermal runaway condition originating in any one of the cells 16 of the battery pack 12, with the multilayer thermal insulator 10 being disposed on in inner face of the casing 14 and about the cells 16, as illustrated in a fragmentary view of FIG. 2, is controlled and contained in the battery pack 12 via the multilayer thermal insulator 10, such that flame propagation outwardly from the casing 14 is prevented for at least 10 minutes at an internal cell temperature ranging between 800-1500° C., and an outer surface temperature of the casing 14 is maintained to be less than 500° C. for 5 minutes. Accordingly, passengers within a passenger compartment 17 of the vehicle EV are shielded against exposure to flame and high temperature therefrom, as is any dielectric member 19 along an outer surface of the casing 14, such as a cationic coating, by way of example and without limitation, from erupting into flame. It is to be understood that the insulator 10 can be disposed along an inner surface of an upper case wall 14a, or about the entirety of the casing 14, as desired.

The insulator 10 is formed of a relatively thin, such as having a thickness of about 2.0 mm, and flexible multilayer wall, also referred to as wall 18. The wall 18, being thin and flexible, can be contoured as desired to provide a protective outer barrier about an upper surface of the cells 16, or about the entirety of an outer periphery of the cells 16.

The wall 18, in the non-limiting embodiment illustrated, as best shown schematically in a fragmentary side view of FIG. 2, includes a plurality of layers. In accordance with one aspect, the plurality of layers includes a plurality of layers of interlaced mineral material, wherein the interlaced mineral material includes interlaced mineral yarns and/or interlaced mineral fibers. In the non-limiting embodiment illustrated in FIG. 2, the plurality of layers includes an outer layer 20 of interlaced mineral yarns. The mineral yarns of the outer layer 20 are preferably interlaced in a weaving process to form a tight weave structure using a tight plain weave pattern, by way of example and without limitation. The outer layer 20, upon being assembled to form the wall 18, has an outer surface 20a and an inner surface 20b, wherein a first flame-resistant coating 22 is bonded to the outer surface 20a. The wall 18 further includes an intermediate layer 24 of interlaced mineral yarns. The mineral yarns of the intermediate layer 24 are preferably interlaced in a weaving process to form a tight weave structure using a tight plain weave pattern, by way of example and without limitation. A second flame-resistant coating 26 is bonded to the intermediate layer 24. The wall 18 further includes an inner layer 28 of interlaced mineral material, such as mineral yarns. The mineral yarns of the inner layer 28 are preferably interlaced in a weaving process to form a tight weave structure using a tight plain weave pattern, by way of example and without limitation. The intermediate layer 24 is sandwiched and captured between the outer layer 20 and the inner layer 28. The wall 18 further includes an adhesive layer, such as a pressure-sensitive adhesive layer, also referred to as adhesive layer 30, bonded to the inner layer 28, with the adhesive layer 30 facing away from the intermediate layer 24 for adhesion to the casing 14. To fix all the aforementioned layers 20, 24, 28 to one another, at least one filament 32 is stitched, such as in a quilting process, thereby fixing the outer layer 20, the intermediate layer 24, and the inner layer 28 to one another.

The outer layer 20, in accordance with one non-limiting embodiment, is woven with silica multifilaments. The first flame resistant coating 22 is a silicone-based coating, and in one non-limiting embodiment is provided as silicone. The silicone coating 22 directly faces the cells 16, and thus, if any flame is present within a cell or cells 16, the flame first contacts the silicone layer 22, whereupon the silicone layer 22 is caused to change chemical phase and transform into silica, which forms a strong flame barrier to block the direct flame from reaching the intermediate layer 24. The silicone coating 22 can be applied having a coating weight between about 50 gsm to 600 gsm.

The intermediate layer 24, in accordance with one non-limiting embodiment, is woven with ceramic multifilaments. The second flame resistant coating 26 is coated on at least one surface of the intermediate layer 24, and can be coated on both sides of the intermediate layer to fully encapsulate the mineral material, shown as mineral yarns, of the intermediate layer 24. As such, the second flame-resistant coating 26 can be sandwiched between the intermediate layer 24 and the inner layer 28, and sandwiched between the intermediate layer 24 and the outer layer 20. The second flame-resistant coating 26 is provided to provide thermal protection properties, and further to prevent end-fray of the mineral yarns of the intermediate layer 24 when the insulator 10 is cut to size, such as in a die-cutting process. The second flame resistant coating 26 can be provided as one of silicone, vermiculite, or graphite.

The inner layer 28, in accordance with one non-limiting embodiment, is woven to form a low gsm mineral fabric to facilitate adhesion of the pressure-sensative adhesive 30 thereon, and in accordance with one non-limiting embodiment, is woven with fiberglass multifilaments.

The pressure-sensitive adhesive layer 30 faces outwardly from the inner layer 28, such that the pressure-sensitive adhesive layer 30 can be exposed for adhesion to an inner surface of the casing 14, thereby orienting the first flame resistant coating 22 to directly face the cells 16. The pressure sensitive adhesive layer 30 is the only adhesive layer of the insulator 10, thereby minimizing the amount of fuel for flame propagation. The pressure-sensitive adhesive layer 30 can be provided as an acrylic material, thereby being heat-resistant. Prior to use and application, the pressure-sensitive adhesive layer 30 can be covered and protected by a release layer, wherein the release layer is selectively removed from the pressure sensitive adhesive layer 30 for use, when desired.

The filament 32, such as a polymer, e.g. nylon thread, or a mineral yarn, such as fiberglass, nomex, aramid filament, coated with polytetrafluoroethylene (PTFE) or silica, by way of example and without limitation, is stitched in a quilting process to fix the outer layer 20, the intermediate layer 24, and the inner layer 28 to one another. To avoid contaminating stitching needles during quilting, the pressure sensitive adhesive layer 30 is preferably applied to the inner layer 28 after the quilting is completed, along with the release layer, if desired. Then, the quilted wall 18 can be cut to size. The quilted wall 18 allows the individual layers 20, 24, 28 to shift relative to one another between stitched filaments 32, thereby reducing conduction of heat, with air layers between the layers 20, 24, 28 further insulating against the transfer of heat through the insulator 10.

In accordance with another aspect, a method of constructing a flexible multilayer battery pack insulator 10 includes: interlacing mineral yarns to form an outer layer 20 having an outer surface 20a and an inner surface 20b. Further, bonding a first flame-resistant coating 22 to the outer surface 20a of the outer layer 20. Further, interlacing mineral yarns to form an intermediate layer 24. Further, bonding a second flame-resistant coating 26 to the intermediate layer 24. Further, interlacing mineral yarns to form an inner layer 28. Further, arranging the intermediate layer 24 between the outer layer 20 and the inner layer 28, and then, stitching at least one filament 32 and fixing the outer layer 20, the intermediate layer 24, and the inner layer 28 to one another to form a multilayer wall 18. Then, bonding a pressure-sensitive adhesive 30 to the inner layer 28, and cutting the multilayer wall 18 to size.

The method further includes leaving the outer layer 20, the intermediate layer 24, and the inner layer 28 in detached relation from one another other than where stitched together by the at least one filament 32.

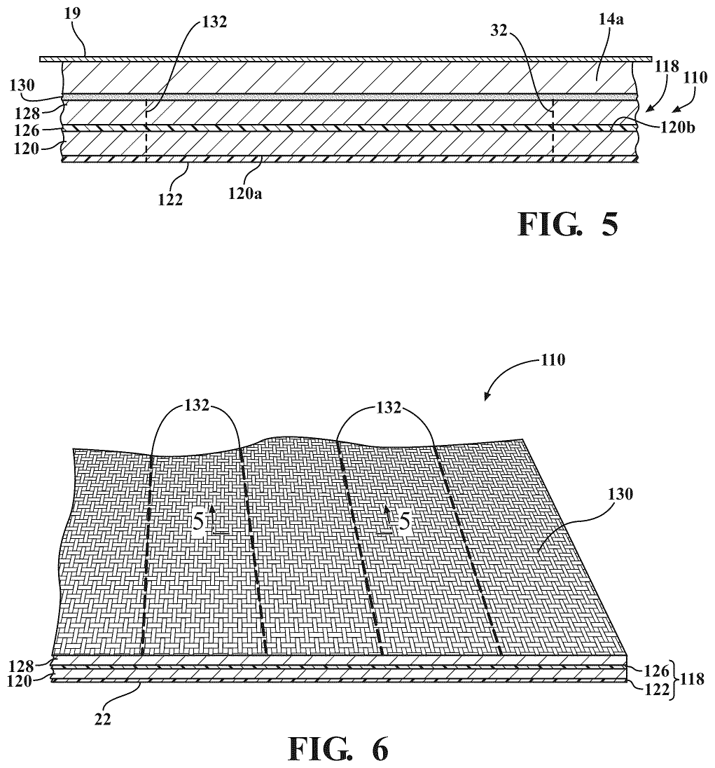

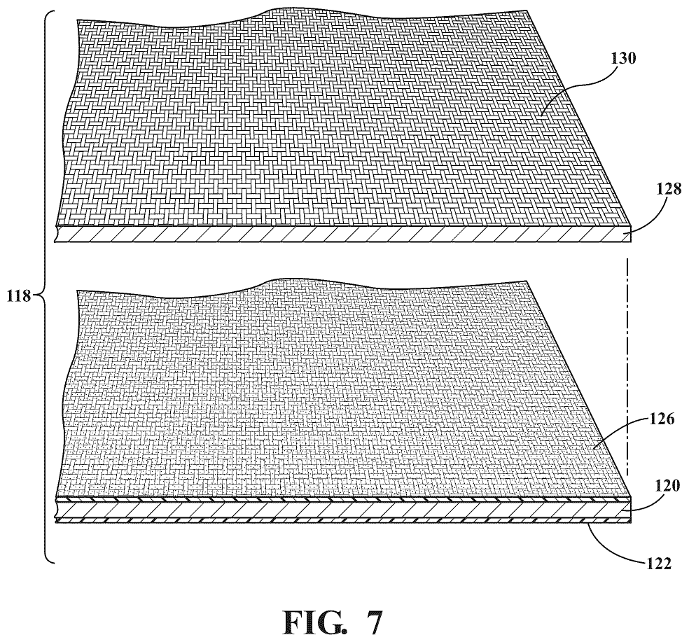

In accordance with another aspect of the disclosure, a wall 118 of a multilayer thermal insulator, also referred to as insulator 110, constructed in accordance with another non-limiting embodiment illustrated, as best shown schematically in a fragmentary side view of FIG. 5, includes a plurality of layers. In accordance with one aspect, the plurality of layers includes a plurality of layers of interlaced material, wherein the interlaced material includes interlaced yarns and/or interlaced fibers. In the non-limiting embodiment illustrated in FIG. 5, the plurality of layers includes an outer layer 120 of interlaced mineral yarns and/or interlaced mineral fibers. The mineral yarns of the outer layer 120 can be interlaced as a knitted or woven fabric, and are preferably interlaced in a weaving process to form a tight weave structure using a tight plain weave pattern, by way of example and without limitation. Otherwise, mineral fibers can be interlaced with one another to form the outer layer 120 as a nonwoven material via any desired nonwoven process. The outer layer 120, upon being assembled to form the wall 118, has an outer surface 120a and an inner surface 120b, wherein a first flame-resistant coating 122 is bonded to the outer surface 120a.

The wall 118 further includes an inner layer 128 of interlaced mineral yarns and/or interlaced fibers. A second flame-resistant coating 126 is bonded to the inner layer 128, wherein the second flame-resistant coating 126 directly abuts the interlaced mineral yarns or interlaced fibers of the outer layer 120. A such, the second flame-resistant coating 126 is sandwiched between the inner layer 128 and the outer layer 120 in abutting relation with the inner layer 128 and the outer layer 120. The mineral yarns of the inner layer 128 can be interlaced as a knitted or woven fabric, and are preferably interlaced in a weaving process to form a tight weave structure using a tight plain weave pattern, by way of example and without limitation. Otherwise, mineral fibers can be interlaced with one another to form the inner layer 128 as a nonwoven material via any desired nonwoven process.

The wall 118 further includes an adhesive layer, such as a pressure-sensitive adhesive 130, bonded to the inner layer 128, with the adhesive 130 facing away from the outer layer 120 for adhesion to the casing 14. To fix the aforementioned outer and inner layers 120, 128 to one another, at least one filament 132 is stitched, such as in a quilting process, thereby fixing the outer layer 120 and the inner layer 128 to one another.

The outer layer 120, in accordance with one non-limiting embodiment, is woven with silica and/or ceramic multifilaments, with the outer layer 120 ranging from 260 gsm to 1100 gsm. The first flame resistant coating 122 is a silicone-based coating, and in one non-limiting embodiment is provided as silicone. The silicone coating 122 directly faces the cells 16, and thus, if any flame is present within a cell or cells 16, the flame first contacts the silicone layer 122, whereupon the silicone layer 122 is caused to change chemical phase and transform into silica, which forms a strong flame barrier to block the direct flame from reaching the inner layer 128. The silicone coating 122 can be applied having a coating weight between about 50 gsm to 600 gsm.

The inner layer 128, in accordance with one non-limiting embodiment, is woven to form a low gsm mineral fabric ranging between 260 gsm to 1100 gsm to facilitate adhesion of the pressure-sensitive adhesive layer 130 thereon, and in accordance with one non-limiting embodiment, is woven with fiberglass multifilaments.

The pressure-sensitive adhesive layer 130 faces outwardly from the inner layer 128, such that the pressure-sensitive adhesive layer 130 can be exposed for adhesion to an inner surface of the casing 14, thereby orienting the first flame resistant coating 122 to directly face the cells 16. The pressure sensitive adhesive layer 130 is the only adhesive layer of the insulator 110, thereby minimizing the amount of fuel for flame propagation. The pressure-sensitive adhesive layer 130 can be provided as an acrylic material, thereby being heat-resistant. Prior to use and application, the pressure-sensitive adhesive layer 130 can be covered and protected by a release layer, wherein the release layer is selectively removed from the pressure sensitive adhesive layer 130 for use, when desired.

The filament 132, such as a polymer, e.g. nylon thread, or a mineral yarn, such as fiberglass, nomex, aramid filament, coated with polytetrafluoroethylene (PTFE) or silica, by way of example and without limitation, is stitched in a quilting process to fix the outer layer 120 and the inner layer 128 to one another. To avoid contaminating stitching needles during quilting, the pressure sensitive adhesive layer 130 is preferably applied to the inner layer 128 after the quilting is completed, along with the release layer, if desired. Then, the quilted wall 118 can be cut to size. The quilted wall 118 allows the individual layers 120, 128 to shift relative to one another between stitched filaments, thereby reducing conduction of heat, with air layers between the outer and inner layers 120, 128 further insulating against the transfer of heat through the insulator 110.

In accordance with another aspect, a method of constructing a flexible multilayer battery pack insulator 110 includes: interlacing mineral yarns and/or mineral fibers to form an outer layer 120 having an outer surface 120a and an inner surface 120b. Further, bonding a first flame-resistant coating 122 to the outer surface 120a of the outer layer 120. Further, interlacing mineral yarns and/or mineral fibers to form an inner layer 128. Further, bonding a second flame-resistant coating 126 to the inner layer 128. Further, arranging the outer layer 120 and the inner layer 128 in abutment with one another, and then, stitching at least one filament 132 and fixing the outer layer 120 and the inner layer 128 to one another to form a multilayer wall 118. Then, bonding a pressure-sensitive adhesive 130 to the inner layer 128, and cutting the multilayer wall 118 to size.

The method further includes leaving the outer layer 120 and the inner layer 128 in detached relation from one another other than where stitched together by the at least one filament 132.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible multilayer battery pack insulator for an electric vehicle, comprising:
a multilayer wall including:
a plurality of layers of interlaced mineral material, said plurality of layers including an inner layer having a first exposed, outwardly facing surface and an outer layer having a second exposed, outwardly facing surface;
a first flame-resistant coating bonded to at least one of said plurality of layers;
a pressure-sensitive adhesive bonded to said first exposed, outwardly facing surface of said inner layer; and
at least one filament fixing said plurality of layers to one another.

2. The flexible multilayer battery pack insulator of claim 1, wherein said plurality of layers of interlaced mineral material further includes an intermediate layer sandwiched between said outer layer and said inner layer.

3. The flexible multilayer battery pack insulator of claim 2, wherein said interlaced mineral material of said intermediate layer is woven ceramic yarn.

4. The flexible multilayer battery pack insulator of claim 1, wherein said interlaced mineral material of said inner layer is woven fiberglass yarn.

5. The flexible multilayer battery pack insulator of claim 1, wherein said interlaced mineral material of said outer layer is woven silica yarn.

6. The flexible multilayer battery pack insulator of claim 2, wherein said outer layer, said intermediate layer, and said inner layer are not bonded to one another with an adhesive material.

7. The flexible multilayer battery pack insulator of claim 1, wherein said pressure-sensitive adhesive layer is the only adhesive layer of said multilayer wall.

8. The flexible multilayer battery pack insulator of claim 2, wherein said first flame-resistant coating is bonded to said second exposed, outwardly facing surface of said outer layer.

9. The flexible multilayer battery pack insulator of claim 8, further including a second flame-resistant coating bonded to said intermediate layer.

10. The flexible multilayer battery pack insulator of claim 9, wherein said interlaced mineral material of said intermediate layer is encapsulated by said second flame-resistant coating.

11. The flexible multilayer battery pack insulator of claim 9, wherein said second flame-resistant coating is one of silica, vermiculite, and graphite.

12. The flexible multilayer battery pack insulator of claim 1, wherein said first flame resistant coating is a silicone-based coating.

13. The flexible multilayer battery pack insulator of claim 12, wherein said first flame resistant coating has a weight between about 50 gsm to 600 gsm.

14. The flexible multilayer battery pack insulator of claim 1, further including a second flame-resistant coating bonded to said inner layer.

15. The flexible multilayer battery pack insulator of claim 14, wherein said second flame-resistant coating is sandwiched between said inner layer and said outer layer in abutting relation with said inner layer and said outer layer.

16. The flexible multilayer battery pack insulator of claim 15, wherein said first flame resistant coating is a silicone-based coating.

17. The flexible multilayer battery pack insulator of claim 16, wherein said second flame resistant coating is a silicone-based coating.

18. The flexible multilayer battery pack insulator of claim 15, wherein said interlaced mineral material of said inner layer is interlaced mineral yarns of silica and/or ceramic.

19. The flexible multilayer battery pack insulator of claim 18, wherein said interlaced mineral material of said outer layer is interlaced mineral yarns of silica and/or ceramic.

20. A method of constructing a flexible multilayer battery pack insulator, comprising:
interlacing mineral material to form an outer layer having an outer surface and an inner surface;
bonding a first flame-resistant coating to the outer surface of the outer layer;
interlacing mineral material to form an inner layer;
arranging the outer layer and the inner layer in overlying relation with one another;
stitching at least one filament and fixing the outer layer and the inner layer to one another to form a multilayer wall;
bonding a pressure-sensitive adhesive to the inner layer; and
cutting the multilayer wall to size.
